(19) United States
(12) Patent Application Publication
(10) Pub. No.: US 2014/0289691 A1
(43) Pub. Date: Sep. 25, 2014

(54) CIRCUIT DESIGN SUPPORT APPARATUS, CIRCUIT DESIGN SUPPORT METHOD, AND COMPUTER PRODUCT

(71) Applicant: FUJITSU LIMITED, Kawasaki-shi (JP)

(72) Inventor: Akiko KASAI, Kawasaki (JP)

(73) Assignee: FUJITSU LIMITED, Kawasaki-shi (JP)

(21) Appl. No.: 14/156,501

(22) Filed: Jan. 16, 2014

(30) Foreign Application Priority Data
Mar. 25, 2013 (JP) 2013-062350

(51) Int. Cl. G06F 17/50

(52) U.S. Cl. CPC G06F 17/5072
USPC 716/122

(57) ABSTRACT

A circuit design support apparatus includes a processor that is configured to generate area information that indicates a plurality of areas obtained by dividing a predetermined area in a circuit by a constant interval; generate first layout data that indicates arrangement of buffer cells capable of supplying clock signals to other cells, at least one buffer cell being disposed in each of the areas indicated by the area information; generate based on the first layout data, second layout data that indicates arrangement of the buffer cells and arrangement of flip-flop cells disposed in the predetermined area; and output the second layout data.

### CROSS REFERENCE TO RELATED APPLICATIONS

This application is based upon and claims the benefit of priority of the prior Japanese Patent Application No. 2013-062350, filed on Mar. 25, 2013, the entire contents of which are incorporated herein by reference.

### FIELD

The embodiments discussed herein are related to a circuit design support apparatus, a circuit design support method, and computer product.

### BACKGROUND

In the design of a layout of a circuit, a conventionally known technique includes manually designing or automatically generating a clock tree. For example, according to an existing technique, after disposing flip-flops (hereinafter referred to as “FFs”), clock buffers are inserted such that clock skew becomes smaller based on Manhattan lengths of multiple FFs (see, e.g., Japanese Laid-Open Patent Publication No. H10-229128).

However, in layout design, for example, cells are arranged such that clock buffers at the last stage of a clock tree and FFs are brought closer to each other so as to satisfy a clock skew condition and conditions related to data signal lines, etc. of the FFs. Therefore, the processing amount required for the arrangement of the cells problematically increases.

### SUMMARY

According to an aspect of an embodiment, a circuit design support apparatus includes a processor that is configured to generate area information that indicates a plurality of areas obtained by dividing a predetermined area in a circuit by a constant interval; generate first layout data that indicates arrangement of buffer cells capable of supplying clock signals to other cells, at least one buffer cell being disposed in each of the areas indicated by the area information; generate based on the first layout data, second layout data that indicates arrangement of the buffer cells and arrangement of flip-flop cells disposed in the predetermined area; and output the second layout data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of an example of operation by a circuit design support apparatus;

FIG. 2 is an explanatory view of a CAD flow example;

FIG. 3 is a block diagram of an example, of a hardware, configuration of the circuit design support apparatus;

FIG. 4 is a block diagram of a functional configuration example of the circuit design support apparatus;

FIG. 5 is an explanatory view of an area size table according to clock buffer type;

FIG. 6 is an explanatory view of an example of area information;

FIG. 7 is an explanatory view of an example of last stage clock buffer cells disposed in respective areas;

FIG. 8 is an explanatory view of a clock tree example;

FIG. 9 is an explanatory view of an example with cells of FFs arranged;

FIG. 10 is an explanatory view of a generation example 1;

FIG. 11 is an explanatory view of an example of correlation information;

FIG. 12 is an explanatory view of a determination example;

FIG. 13 is an explanatory view of a generation example 2;

FIG. 14 is an explanatory view of a correlation information example 2;

FIG. 15 is an explanatory view of a connection example in the generation example 2;

FIG. 16 is an explanatory view of a generation example 3;

FIG. 17 is an explanatory view of a correlation information example 3;

FIG. 18 is an explanatory view of a connection example in the generation example 3;

FIG. 19 is an explanatory view of an example of concentrated FF cells;

FIG. 20 is a first flowchart of a design supporting process procedure example 1 by the circuit design support apparatus;

FIG. 21 is a second flowchart of the design supporting process procedure example 1 by the circuit design support apparatus;

FIG. 22 is a third flowchart of the design supporting process procedure example 1 by the circuit design support apparatus;

FIG. 23 is a fourth flowchart of the design supporting process procedure example 1 by the circuit design support apparatus; and

FIG. 24 is a flowchart of a design supporting process procedure example 2 by the circuit design support apparatus.

### DESCRIPTION OF EMBODIMENTS

Embodiments of a circuit design support apparatus, a circuit design support method, and computer product will be described in detail with reference to the accompanying drawings.

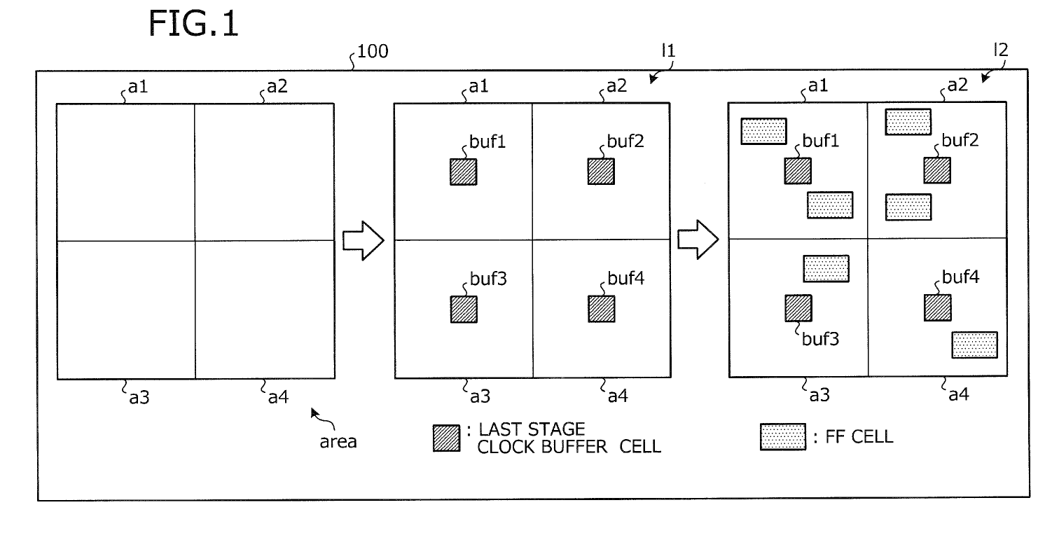

FIG. 1 is an explanatory view of an example of operation, by a circuit design support apparatus. A circuit design support apparatus 100 is a computer that supports the design of layout data of a circuit such as a semiconductor integrated circuit. First, the circuit design support apparatus 100 generates area information that indicates multiple areas a1 to a4 obtained by dividing a predetermined area “area” in the circuit by a constant interval. The constant interval is determined based on the drive capability of a clock buffer. The predetermined area “area” is a cell arrangeable area and is an area designed by a standard cell such as a digital circuit in the circuit.

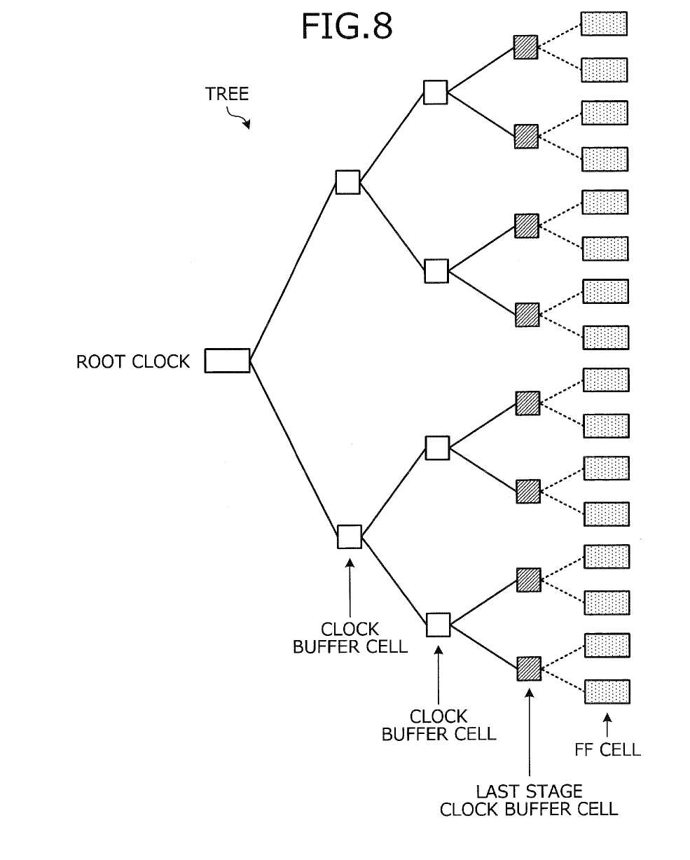

The circuit design support apparatus 100 generates first layout data 11 that indicates an arrangement of buffer cells disposed at least one for each of the multiple areas a1 to a4 indicated by the generated area information and capable of supplying clock signals to other cells. In the example of FIG. 1, in the multiple areas a1 to a4, respective clock buffer cells buf1 to buf4 are disposed. The buffer cells capable of supplying clock signals to other cells are clock buffers at the last stage in a clock tree, for example. Therefore, in the first layout data 11, cells included in the clock tree are arranged. For example, it is assumed that the clock tree has the same number of stages from the clock supply source to each of the last-stage clock buffer cells and the intervals at which the buffer cells are arranged and the wiring lengths thereof are equal for each path from the clock supply source to each of the last-stage clock buffer cells. An example of the clock tree is depicted in FIG. 8.

Based on the generated first layout data 11, the circuit design support apparatus 100 generates second layout data 12 that indicates the arrangement of the clock buffer cells and the arrangement of FF cells disposed in the predetermined area “area”. For example, the circuit design support apparatus 100 uses an automatic arrangement/wiring tool to generate based on the first layout data 11, the second layout data 12 that indicates the arrangement of cells in the clock tree and the arrangement of cells, excluding those of the clock tree, disposed in the predetermined area “area”.

The circuit design support apparatus 100 outputs the generated second layout data 12. The form of output may be, for example, output to a storage device such as random access memory (RAM) and a disk included in the circuit, design support apparatus 100 and output to another device capable of connection to the circuit design support apparatus 100 via the Internet.

As a result, since the last-stage clock buffer cells are within a constant distance, the clock skew can satisfy a constant condition regardless of the arrangement of the FF cells. Therefore, the processing amount required for the arrangement of the FF cells can be reduced. The constant condition is a condition defined by a designer and is determined by the constant interval at the time of division.

The circuit design support apparatus 100 connects a last-stage clock buffer cell in an area to FF cells in the area. As a result, the FF cells are connected to the last-stage clock buffer cells, which are located within a close distance.

For example, in a technique of automatically designing a clock tree by the clock tree synthesis (CTS) for a large-scale circuit, the processing amount for reducing the clock skew is great. Therefore, for example, to make the clock skew as small as possible for a large-scale circuit, the design of the clock tree and the arrangement of the FF cells are manually performed, nonetheless, the FF cells must be arranged in a vicinity of the clock buffer cells at the last stage in the clock tree. As a result, the manual arrangement of the FF cells reduces the degree of freedom of the FF cell arrangement. On the other hand, in the case of the circuit design support apparatus 100, since the last-stage clock buffer cells are arranged within a constant distance, the degree of freedom of the FF cell arrangement can be improved.

For example, in the case of manual design, when a logic change occurs such as an addition of an FF cell, it is difficult to make corrections such as changing the last-stage clock buffer that is to be connected so as to satisfy the constant condition of the clock skew. On the other hand, in the case of the circuit design support apparatus 100, since the constant condition of the clock skew can be satisfied regardless of the position at which the FF cell is arranged, modifications such as an addition of an FF cell can be facilitated.

Circuit logic design and circuit layout design will be described briefly with reference to a flow.

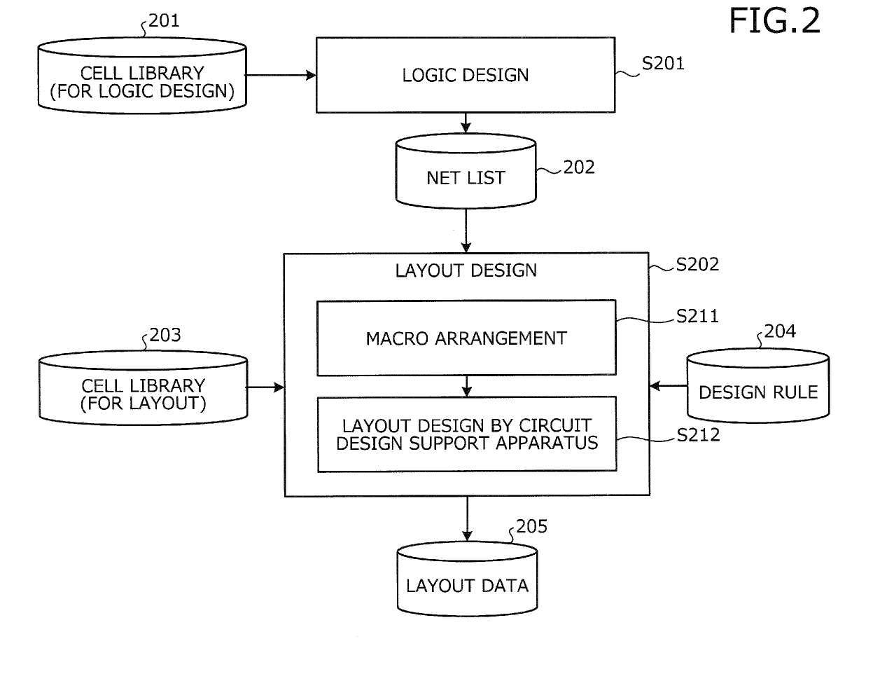

FIG. 2 is an explanatory view of a CAD flow example. A CAD flow according to the present embodiment will briefly be described. For example, in the circuit logic design, a net list 202 of a circuit is designed based on a cell library 201 that defines functions of cells for logic design (step S201). The net list 202 is information that indicates connection relationships among cells in the circuit under design, for example. The net list 202 is described in a hardware description language or a system description language such as Verilog and Very High Speed Integrated Circuit Hardware Description Language (VHDL), for example.

In the layout design, the connection relationships between the cells indicated by the net list 202 acquired in the logic design is maintained, and the arrangement of the cells and the wiring of the cells are performed based on a design rule 204 and a cell library 203 (step S202). The cell library 203 has for each type of cell, layout data of the cells. The design rule 204 has information on layers for forming the cells in the circuit and rules in the layout design such as a pitch between wires. In the layout design, after macro such as a RAM is disposed (step S211), the layout design by the circuit design support apparatus 100 is performed (step S212) and layout data 205 is generated.

Although not depicted, after the layout design, timing analysis, etc. are performed and if the timing analysis result is abnormal, modifications, etc. are made on the cell arrangement through the layout design.

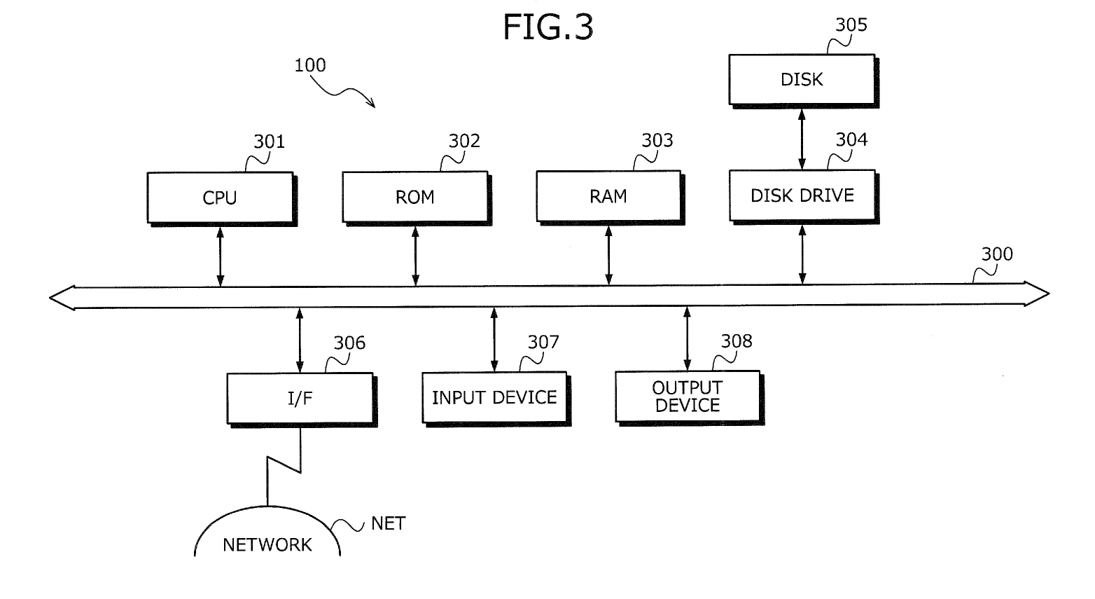

FIG. 3 is a block diagram of an example of a hardware configuration of the circuit design support apparatus. As depicted in FIG. 3, a circuit design support apparatus 100 includes a CPU 301, ROM 302, RAM 303, a disk drive 304, and a disk 305. The circuit design support apparatus 100 has an I/F 306, an input device 307, and an output device 308. The components are respectively connected by a bus 300.

The CPU 301 governs overall control of the circuit design support apparatus 100. The ROM 302 stores programs such as a boot program. The RAM 303 is used as a work area of the CPU 301. The disk drive 304, under the control of the CPU 301, controls the reading and writing of data with respect to the disk 305. The disk 305 stores data written thereto under the control of the disk drive 304. Examples of the disk 305 include a magnetic disk, an optical disk, and the like.

The I/F 306 is connected to a network NET such as a local area network (LAN), a wide area network (WAN), and the Internet, via a communication line, and is further connected to other apparatuses through the network NET. The I/F 306 administers an internal interface with the network NET and, controls the input and output of data with respect to external apparatuses. A modem, a LAN adapter, and the like may be adopted as the I/F 306.

The input device 707 is an interface through which various types of data is input via user operation of a keyboard, mouse, and the like. The input device 707 may further taken in images and moving pictures from a camera. The input device 707 may further take in audio from a microphone. The output device 708 is an interface that outputs data under the instruction of the CPU 701. Examples of the output device 708 include a display, printer, and the like.

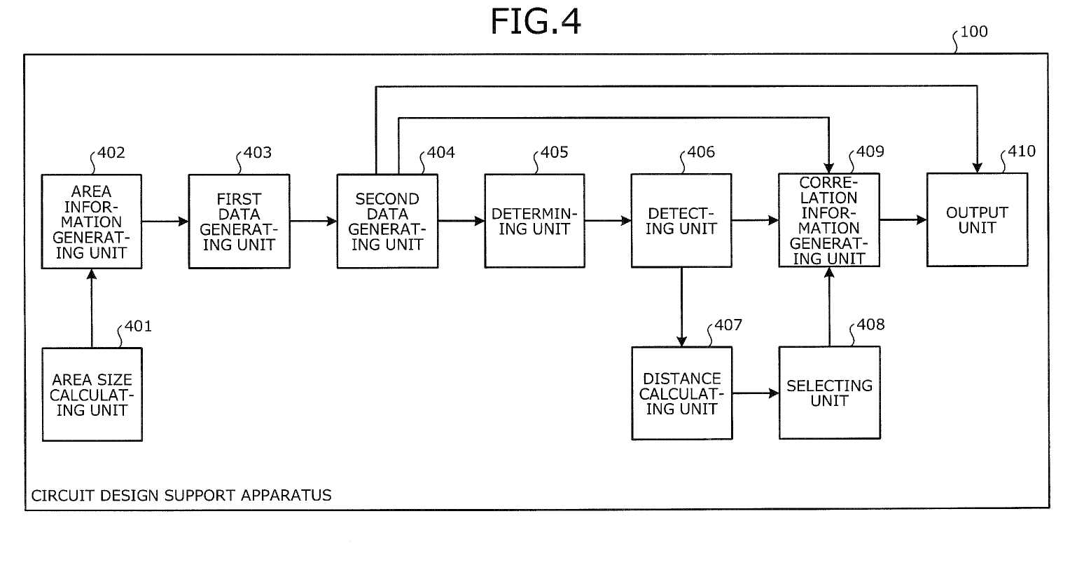

FIG. 4 is a block diagram of a functional configuration example of the circuit design support apparatus. The circuit design support apparatus 100 has an area size calculating unit 401, an area information generating unit 402, a first data generating unit 403, and a second data generating unit 404. The circuit design support apparatus 100 also has a determining unit 405, a detecting unit 406, a distance calculating unit 407, a selecting unit 408, a correlation information generating unit 409, and an output unit 410. The processes of the units are coded in a calculation program stored in a storage device accessible by the CPU 301. The CPU 301 reads the calculation program from the storage device and executes the processes coded in a test supporting program. As a result, the processes of the units are implemented. Process results of the units are stored to a storage device such as the RAM 303 and the disk 305, for example.

The area size calculating unit 401 calculates the size of areas dividing the predetermined area “area” in a circuit based on the number of FFs to which a clock buffer can normally supply clock signals. The predetermined area “area” in the circuit may be, for example, an area where standard cells can be arranged, excluding the areas disposed with analog circuits and macros, or may be an area specified by a user. The number of FFs that can be supplied with the clock signals is determined based on the drive capability of the clock buffer and is referred to as a connectable number.

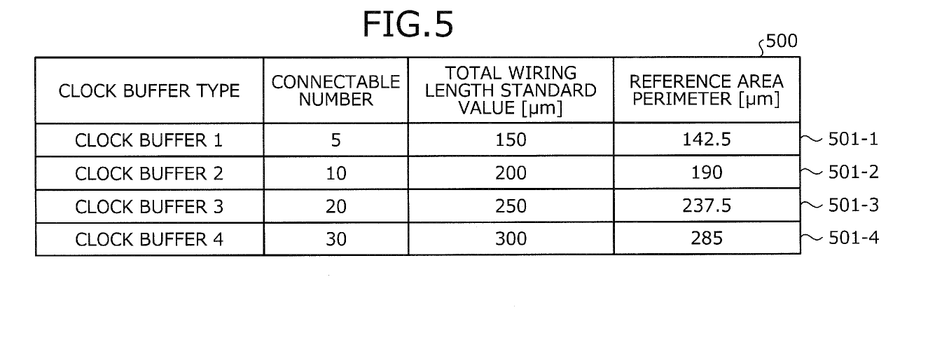

FIG. 5 is an explanatory view of an area size table according to cloak buffer type. A table 500 is information that correlates the connectable number, a total wiring length standard value, and a perimeter of an area dividing the predetermined area “area” when the clock buffer is at the last stage, for each type of the clock buffer. For example, the table 500 stores records 501-1 to 501-4 correlated with clock buffers 1 to 4, respectively. The total wiring length standard value is a length based on empirical values of wiring connecting the last-stage clock buffer cells and flip-flop cells.

In this case, for example, considering wiring of the worst case, the perimeter of the area is assumed to be calculated by considering a margin of the total wiring length standard value. For example, the perimeter of the area is represented as Equation (1).

Perimeter of Area=Total Wiring Length Standard Value×Margin (1)

For example, when the margin is set to 5 [%] based on the empirical values, the clock buffer 2 has a perimeter of 200×0.95, which is 190 [μm].

The area information generating unit 402 generates area information that indicates multiple areas obtained by dividing the predetermined area “area” in the circuit by a constant interval. The constant interval is a value based on the perimeter of a reference area calculated by the area size calculating unit 401 and is stored in the storage device such as the RAM 303 and the disk 305.

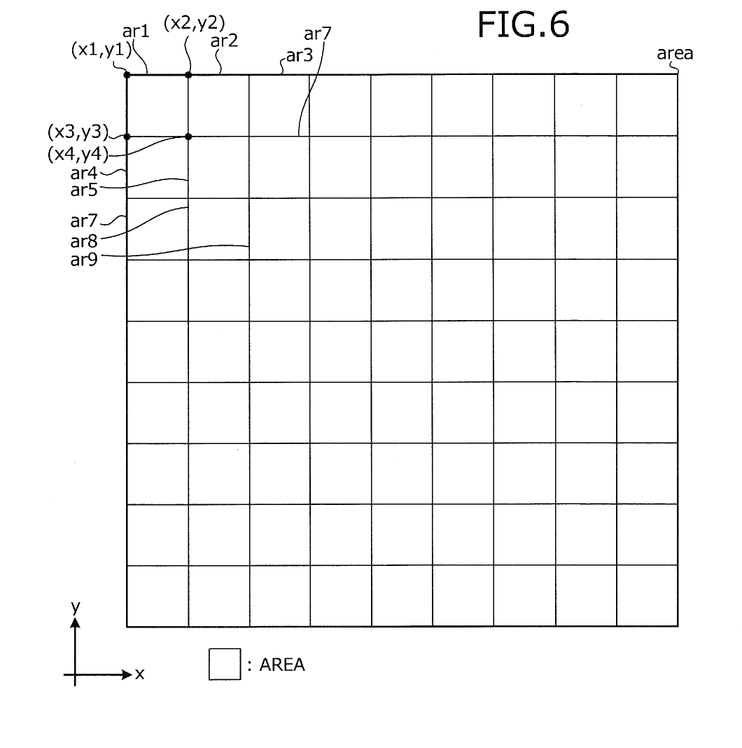

FIG. 6 is an explanatory view of an example of the area information. For example, for each area indicated by identification information, the area information has vertex coordinates in the area. For example, among the multiple areas obtained by dividing the predetermined area “area”, ar1 to ar9 are added representatively to areas located on the left upper end. For example, the area information includes information related to four vertices, i.e., a vertex (x1, y1), a vertex (x2, y2), a vertex (x3, y3), and a vertex (x4, y4), for the area ar1.

The first data generating unit 403 generates the first layout data 11, which indicates the clock buffer cell disposed in each of the multiple areas indicated by the area information and capable of supplying clock signals to other cells, and the position of the clock buffer cell. A clock buffer cell capable of supplying clock signals to other cells is a clock buffer cell at the last stage included in a clock tree and is a buffer cell directly connected to FF cells.

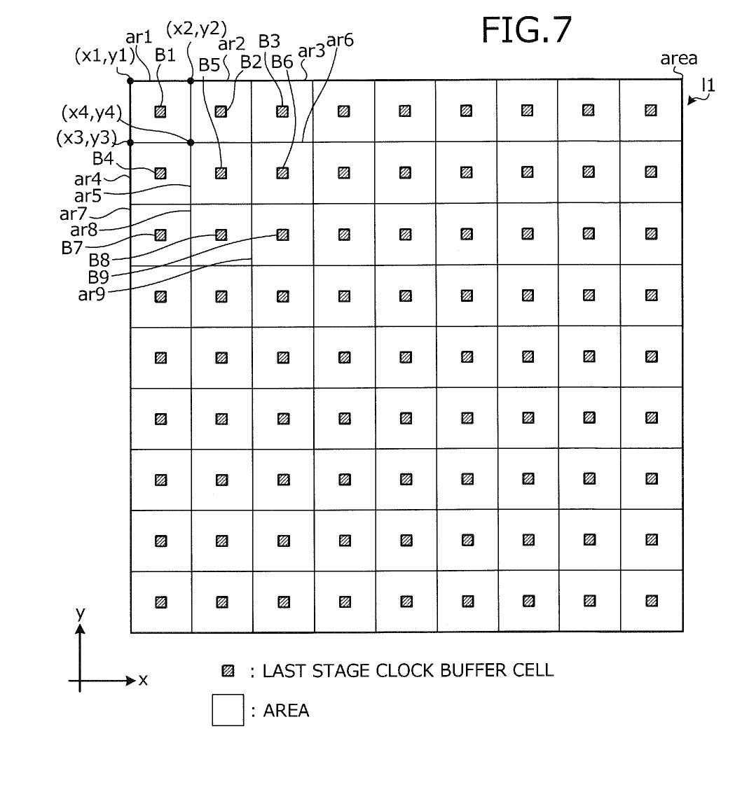

FIG. 7 is an explanatory view of an example of the last-stage clock buffer cells disposed in respective areas. For example, the first data generating unit 403 generates the layout data of a clock tree disposed in the predetermined area “area” on the assumption that the number of stages from the clock supply source to the last-stage clock buffer cells is constant. For example, the first data generating unit 403 arranges the last-stage clock buffer cells at the center in the respective areas. As a result, a clock tree with reduced skew is generated. The arrangement of a macro such as the RAM 303 is completed before the arrangement of the clock buffer cells.

For example, in the area ar1, a clock buffer cell B1 is disposed; in the area ar2, a clock buffer cell B2 is disposed; in the area ar3 a clock buffer cell B3 is disposed; and in the area ar4, a clock buffer cell B4 is disposed. For example, in the area ar5, a clock buffer cell B5 is disposed; in the area ar6, a clock buffer cell B6 is disposed; in the area ar7, a clock buffer cell B7 is disposed; in the area ar8, a clock buffer cell B8 is disposed; and in the area ar9, a clock buffer cell B9 is disposed.

FIG. 8 is an explanatory view of a clock tree example. A clock tree “tree” generated in this example is assumed to have the same number of stages from a clock supply source “root clock” to each of the last-stage clock buffer cells. The clock tree “tree” is assumed to have paths from the clock supply source “root clock” to each of the last-stage clock buffer cells that respectively have equal arrangement intervals and wiring lengths of the buffer cells. Although FF cells are depicted in FIG. 8 to facilitate understanding, the FF cells are not yet disposed.

Based on the first layout data 11, the second data generating unit 404 generates the second layout data 12, which indicates the arrangement of the clock buffer cells and the arrangement of FF cells disposed in the predetermined area “area”.

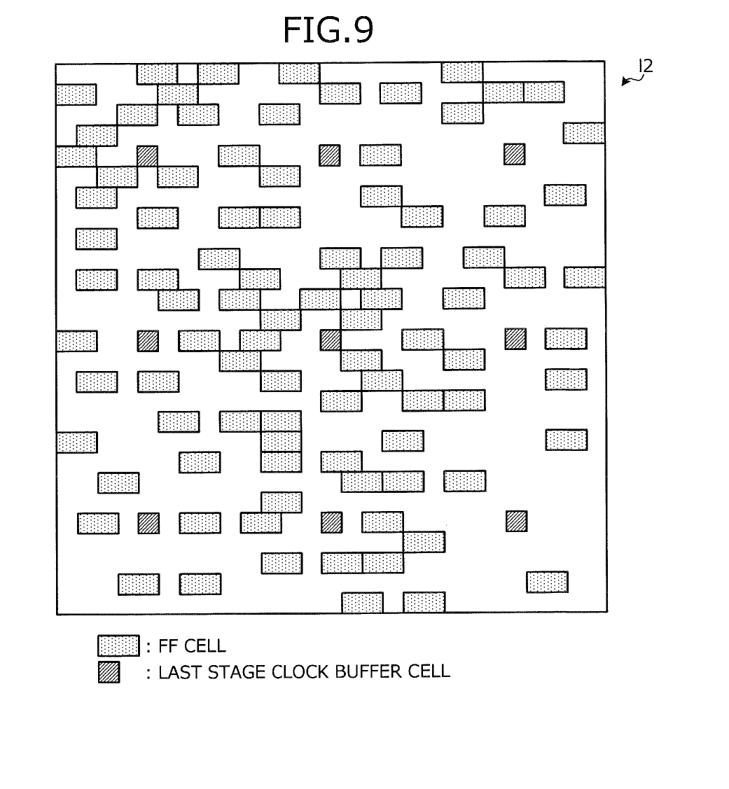

FIG. 9 is an explanatory view of an example with cells of FFs arranged. For example, based on the net list 202, which indicates the circuit, and the first layout data 11, the second data generating unit 404 performs automatic wiring arrangement for cells in the net list 202 to generate the second layout data 12.

The output unit 410 outputs the second layout data 12. The form of output may by storage, to a storage device such as the disk 305, output by the output device 308 such as a display, or the output to another device via the network NET through the I/F 306.

As a result, the FF cells have the clock buffer cells located within a constant distance regardless of positions of arrangement. Therefore, the processing amount required for the arrangement of the FFs can be reduced. By simply connecting the FF cells to the most closely located clock buffer cells based on the second layout data 12, the layout data can be acquired with the clock skew satisfying the constant condition.

A generation example 1 will be described. Based on the second layout data 12, the correlation information generating unit 409 generates for each of the multiple areas indicated by the area information, correlation information in which FF cells in an area are correlated with a clock buffer cell in the area.

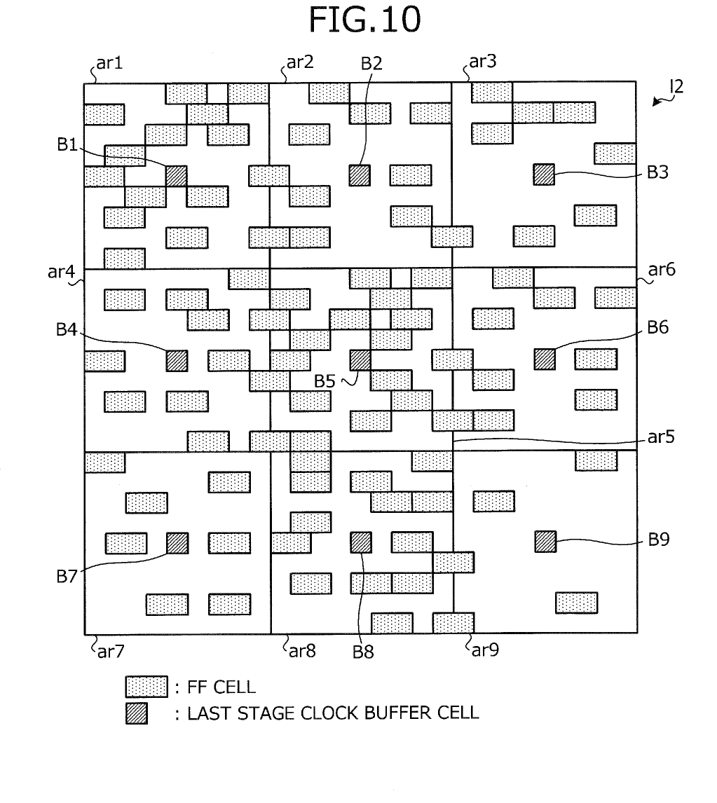

FIG. 10 is an explanatory view of the generation example 1. For example, a cell arrangeable area with cells arranged is divided into multiple areas. In FIG. 10, an FF cell disposed across two areas is assumed to be correlated with the clock buffer in an area on the left side.

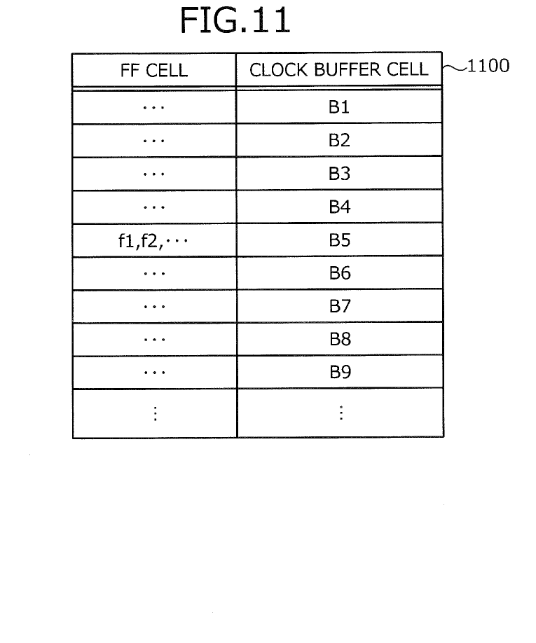

FIG. 11 is an explanatory view of an example of the correlation information. Correlation information 1100 fields for the clock buffer cells and the FF cells. Information is set in the fields and stored as records. In the clock buffer cell fields, identification information is set that indicates clock buffer cells disposed at least one in each area. In the FF cell field, identification information is set that indicates FF cells disposed in the respective areas.

The output unit 410 outputs the second layout data 12 and the correlation information 1100 in a correlated manner. The form of output may be storage to a storage device such as the disk 305, output by the output device 308 such as a display, or output to another device via the network NET through the I/F 306.

As a result, information enabling the connection of the FF cells to the most closely located clock buffer cells can be provided, and facilitation of the design can be achieved.

A generation example 2 will be described. Based on the second layout data 12, the determining unit 405 determines for each of the multiple areas, whether the number of the flip-flop cells in an area is larger or smaller than the connectable number for the buffer cell in the area.

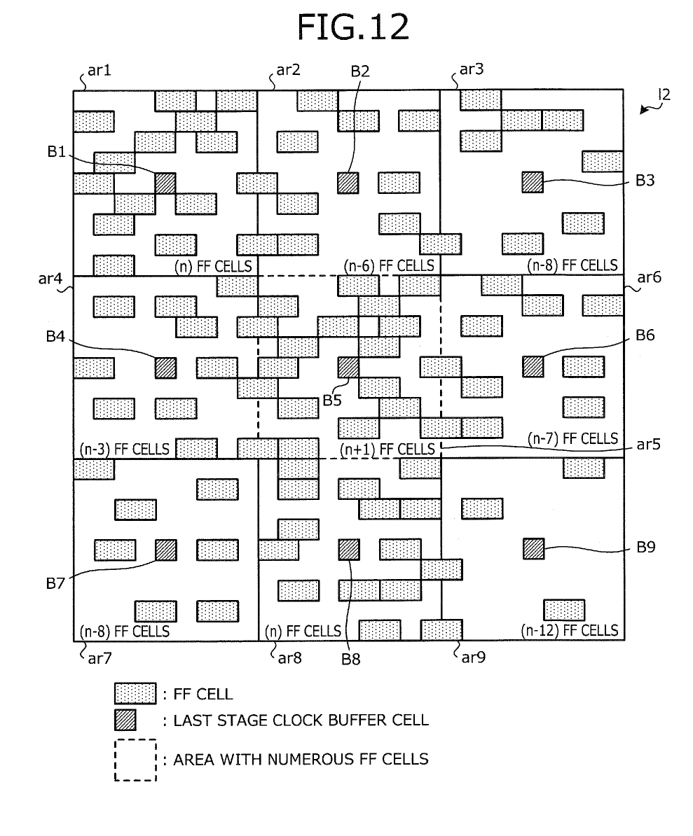

FIG. 12 is an explanatory view of a determination example. Since the number of the FF in the area ar1 is n, it is determined that the number of the FF cells in the area ar1 is the same as the connectable number. Since the number of the FF cells in the area ar2 is (n−6), it is determined that the number of the FF cells in the area a2 is smaller than the connectable number. Since the number of the FF cells in the area ar3 is (n−8), it is determined that the number of the FF cells in the area a3 is smaller than the connectable number.

Since the number of the FF cells in the area ar4 is (n−3), it is determined that the number of the FF cells in the area ar4 is smaller than the connectable number. Since the number of the FF cells in the area ar5 is (n+1), it is determined that the number of the FF cells in the area ar5 is larger than the connectable number. Since the number of the FF cells in the area ar6 is (n−7), it is determined that the number of the FF cells in the area ar6 is smaller than the connectable number.

Since the number of the FF cells in the area ar7 is (n−8), it is determined that the number of the FF cells in the area ar7 is smaller than the connectable number. Since the number of the FF cells in the area ar8 is (n), it is determined that the number of the FF cells in the area ar8 is the same as the connectable number. Since the number of the FF cells in the area ar9 is (n−12), it is determined that the number of the FF cells in the area ar9 is smaller than the connectable number.

An area determined as having a number of FF cells exceeding the connectable number is referred to as an object area. The correlation information generating unit 409 generates the correlation information 1100 in which among the FF cells of the object area, an FF cell other than the FF cells within the connectable number is correlated with a buffer cell in an area determined as having fewer FF cells than the connectable number.

The output unit 410 outputs the second layout data 12 and the correlation information 1100 in a correlated manner. The form of output is the same as described above and therefore, will not be described in detail.

The detecting unit 406 detects an area adjacent to the object area, from among areas determined as having fewer FF cells than the connectable number. As a result, the distance can be prevented from increasing between the FF cells and the clock buffer cells. The detecting unit 406 may detect an area having the smallest number of the FF cells, among the adjacent areas. As a result, even if the difference is large between the number of the FF cells in the object area and the connectable number, the FF cells in the area determined as having more FF cells than the connectable number can be connected to the clock buffer cells in the detected area.

The correlation information generating unit 409 generates the correlation information 1100 in which an FF cell other than the FF cells within the connectable number is correlated with the buffer cell in the detected area.

The distance calculating unit 407 calculates the distance between the buffer cell in the detected area and each of the FF cells in the object area. In ascending order of the calculated distance, the selecting unit 408 selects from among the FF cells in the object area, an FF cell other than the FF cells within the connectable number. The correlation information generating unit 409 generates the correlation information 1100 in which the selected FF cell is correlated with the buffer cell in the detected area.

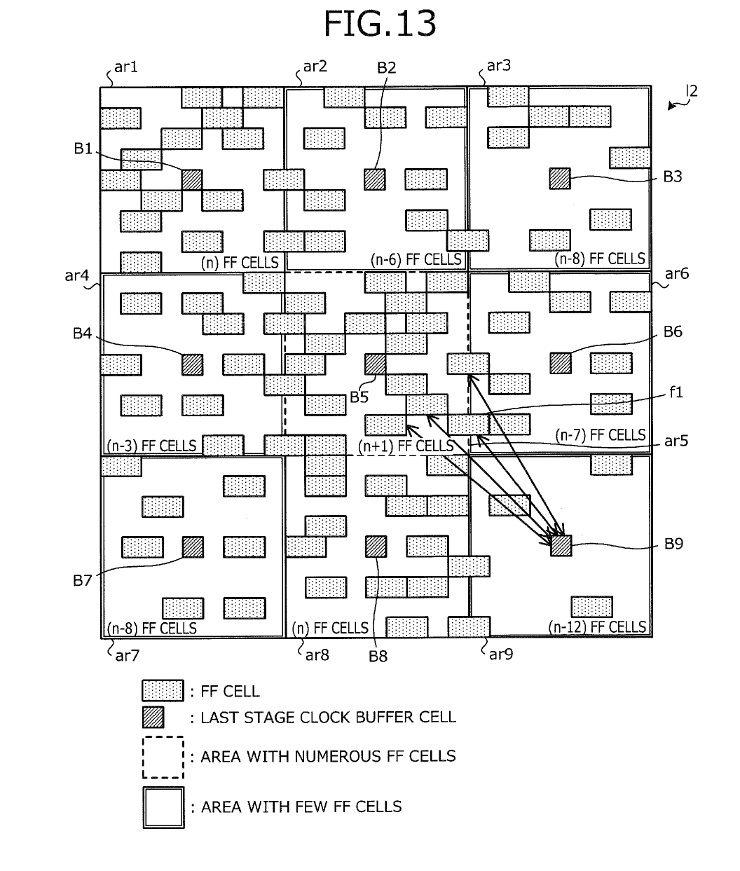

FIG. 13 is an explanatory view of the generation example 2. For example, the detecting unit 406 selects the area ar 9 having the smallest number of the FF cells. For example, the distance calculating unit 407 calculates the distance between the clock buffer cell B9 in the area ar9 and each of the FF cells in the area ar5. Since the difference between the number of FF cells and the connectable number is one in the area ar5, the selecting unit 408 selects one FF cell from among the FF cells in the object area. In the example of FIG. 13, since the distance is the shortest between the FF cell f1 and the clock buffer cell B9 in the area ar9, the selecting unit 408 selects the FF cell f1.

The correlation is generating unit 409 generates the correlation information 1100 in which the FF cell f1 is correlated with the clock buffer cell B9 in the area ar9.

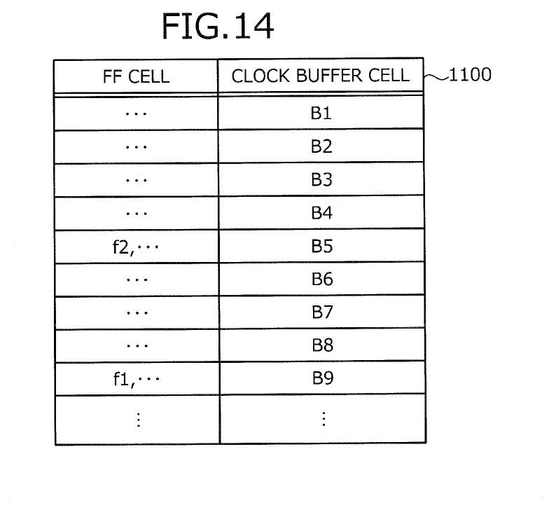

FIG. 14 is an explanatory view of a correlation information example 2. As depicted in FIG. 14, the correlation information generating unit 409 may generate the correlation information by making a change such that the FF cell f1 included in the correlation information 1100 described above is correlated with the clock buffer cell B9 in the area ar9.

The output unit 410 outputs the second layout data 12 and the correlation information 1100 in a correlated manner. The form of output may be storage to a storage device such as the disk 305, output by the output device 308 such as a display, or output to another device via the network NET through the I/F 306.

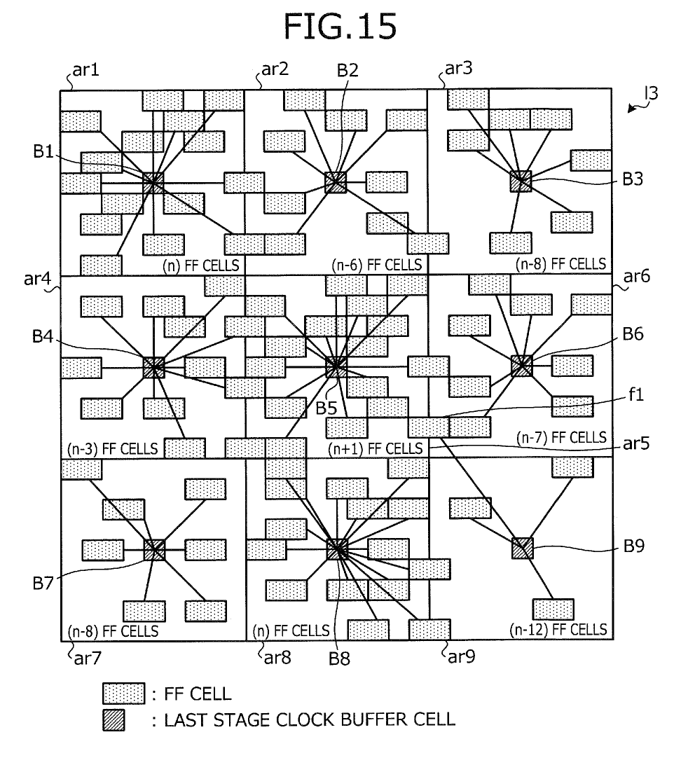

FIG. 15 is an explanatory view of a connection example in the generation example 2. Based on the second layout data 12 and the correlation information 1100, the circuit design support apparatus 100 generates third layout data 13 that indicates the arrangement of the cells indicated by the second layout data 12, and the connection between the FF cells and the clock buffer cells correlated with the FF cells. In the example of FIG. 15, the FF cell f1 is connected to the clock buffer B9 while the other FF cells are connected to the clock buffer cells in the same area as the respective FF cells.

A generation example 3 will be described. For each of the buffer cells in the detected areas, the distance calculating unit 407 calculates the distance between the buffer cell in the detected area and each of the flip-flop cells in the object area. From among combinations of the buffer cells in the detected areas and the flip-flop cells in the object area, the selecting unit 408 selects combinations equivalent in number to a difference. The selecting unit 408 selects the combinations in ascending order of the calculated distances and without selecting in plural, combinations that include the same flip-flop cell. The difference in this case is the difference between the number of the flip-flop cells in the object area and the connectable number.

The correlation information generating unit 409 generates the correlation information 1100 in which the flip-flop cell included in the combination selected by the selecting unit 408 is correlated with the buffer cell included in the selected combination.

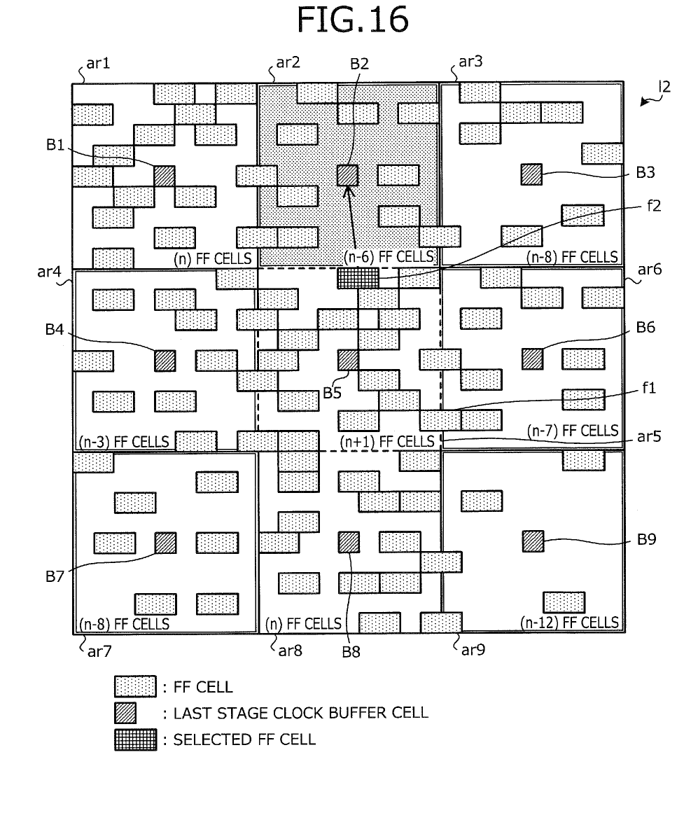

FIG. 16 is an explanatory view of the generation example 3. For example, the distance is shortest between the FF cell f2 and the clock buffer cell B2 in the area ar2, and the difference is one between the connectable number and the number of the flip-flop cells in the area determined as having more FF cells than the connectable number. Therefore, the selecting unit 408 selects one combination, the combination of the FF cell f2 and the clock buffer cell B2 in the area ar2. The correlation information generating unit 409 generates the correlation information 1100 in which the FF cell f2 is correlated with the clock buffer cell 132 in the area ar2.

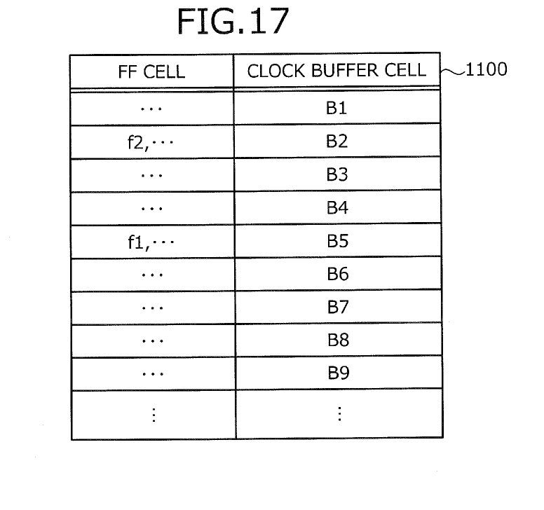

FIG. 17 is an explanatory view of a correlation information example 3. As depicted in FIG. 17, the correlation information generating unit 409 may generate the correlation information by making a change such that the FF cell f2 included in the correlation information 1100 described above is correlated with the clock buffer cell B2 in the area ar2.

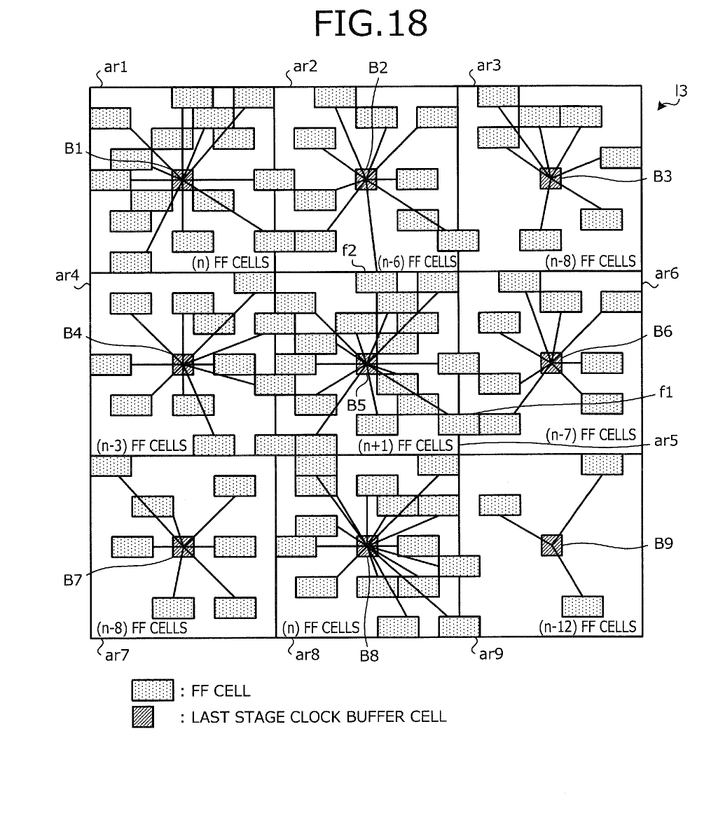

FIG. 18 is an explanatory view of a connection example in the generation example 3. Based on the second layout data 12 and the correlation information 1100, the circuit design support apparatus 100 generates third layout data 13 that indicates the arrangement of the cells indicated by the second layout data 12, and the connection between the FF cells and the clock buffer cells correlated with the FF cells. In the example of FIG. 18, the FF cell f2 is connected to the clock buffer B2 while the other FF cells are connected to the clock buffer cells in the same area as the respective FF cells.

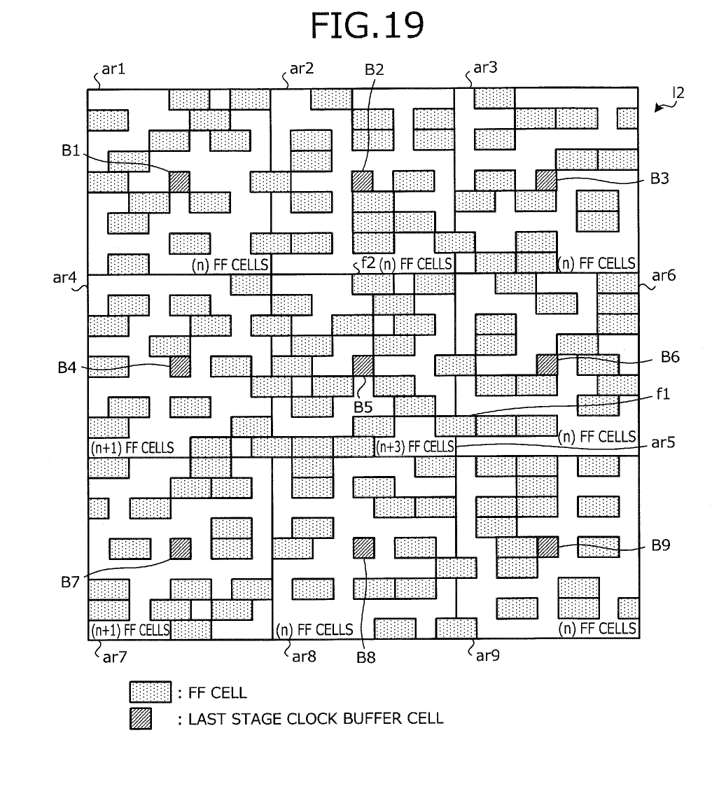

FIG. 19 is an explanatory view of an example of concentrated FF cells. If the adjacent area cannot be obtained by the detection of the detecting unit 406, the output unit 410 outputs information indicating the presence of a large number of FF cells around the object area without generating the correlation information 1100. In the example of FIG. 19, in each of the areas, the number of FF cells is equal to or greater than the connectable number and therefore, the circuit design support apparatus 100 reports to the user that the connection destinations of the FF cells in the area ar3 cannot be changed.

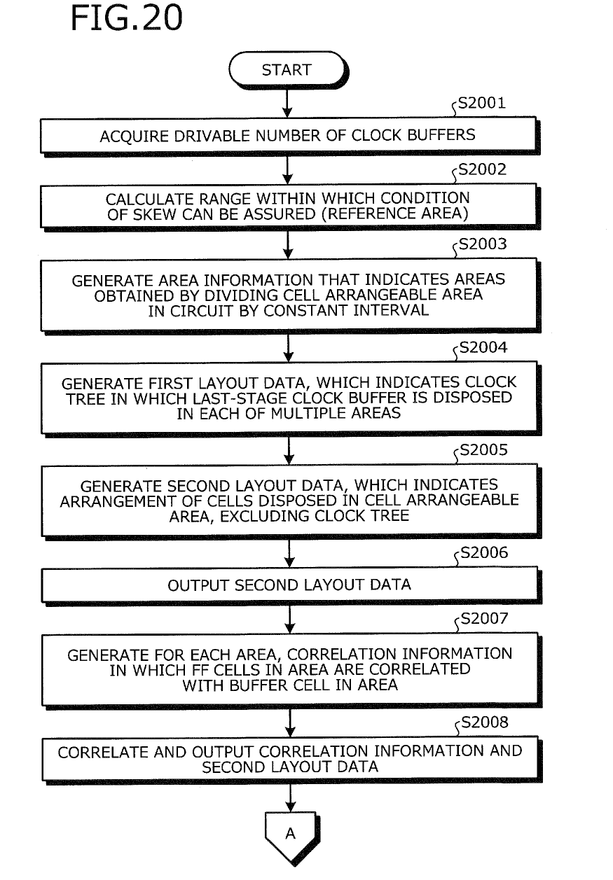

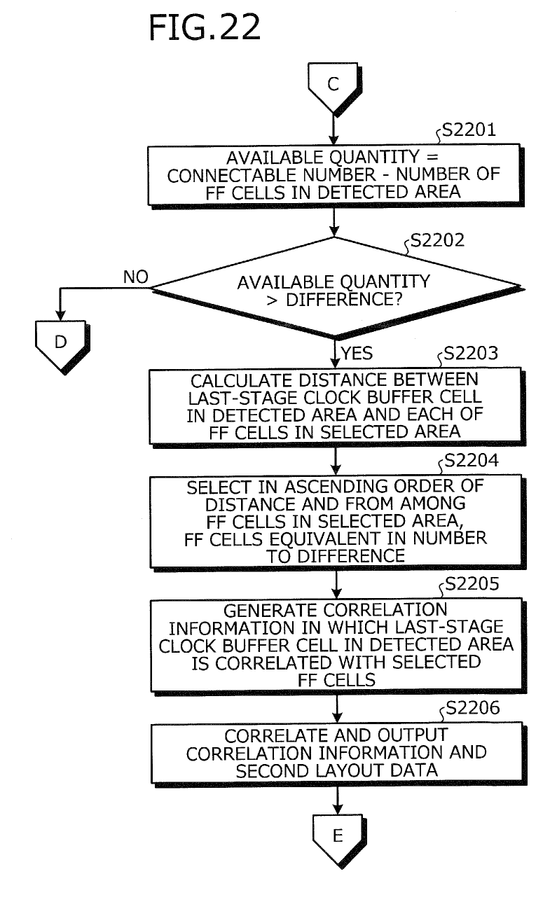

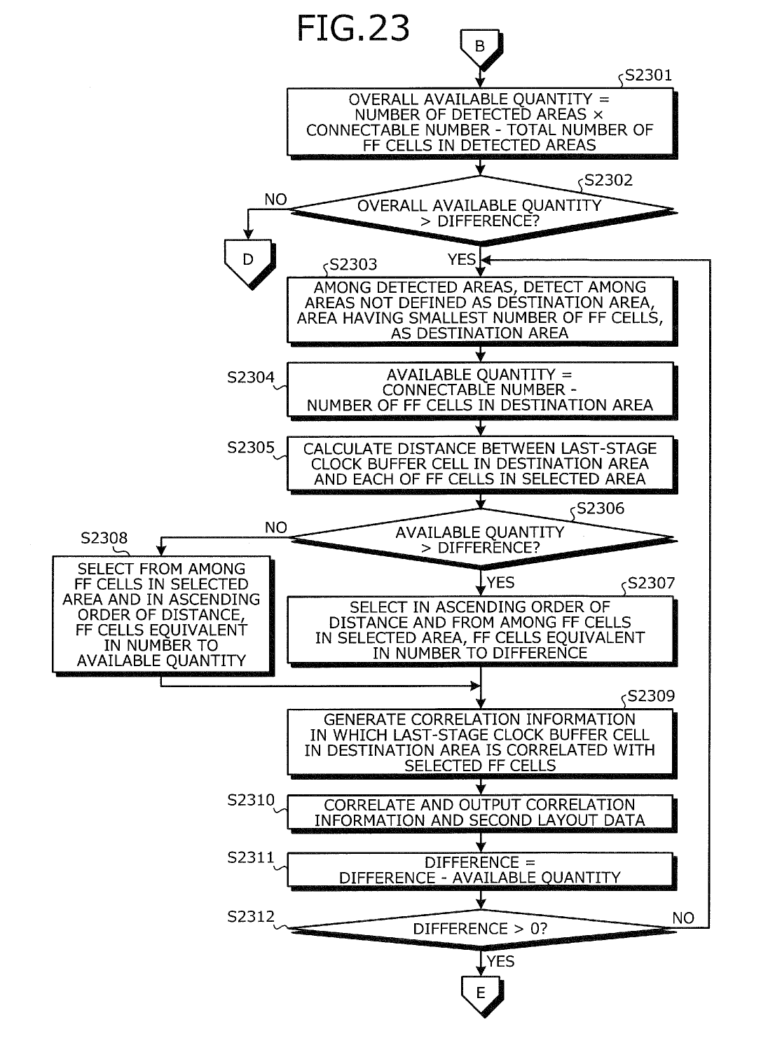

FIGS. 20, 21, 22, and 23 are flowcharts of a design supporting process procedure example 1 by the circuit design support apparatus. The circuit design support apparatus 100 acquires the drivable number of clock buffers (step S2001) and calculates a range within which the condition of skew can be assured (the size of the reference area) (step S2002). In this case, as described above, the perimeter of the reference area is calculated. The circuit design support apparatus 100 generates area information that indicates the areas obtained by dividing the cell arrangeable area in the circuit by a constant interval (step S2003). The constant interval is a value based on the calculated perimeter of the reference area.

The circuit design support apparatus 100 generates the first layout data 11, which indicates a clock tree in which a last-stage clock buffer is disposed in each of the multiple areas (step S2004). Based on the first layout data 11, the circuit design support apparatus 100 generates the second layout data 12, which indicates the arrangement of cells disposed in the cell arrangeable area, excluding the clock tree (step S2005), and outputs the second layout data 12 (step S2006). As a result, since the clock skew satisfies the constant condition regardless of the arrangement of the FF cells, the processing amount required for the arrangement of the FF cells can be reduced.

For each of the multiple areas, the circuit design support apparatus 100 generates the correlation information 1100 in which FF cells in the area are correlated with a buffer cell in the area (step S2007). The circuit design support apparatus 100 correlates and outputs the correlation information 1100 and the second layout data 12 (step S2008). As a result, the process at connecting the FF cells to the most closely located last-stage clock buffer cells can be facilitated.

The circuit design support apparatus 100 counts the number of FF cells in each area (step S2101) and for each area, determines whether the number of the FF cells in the area is larger or smaller than the connectable number for the last-stage clock buffer (step S2102). The circuit design support apparatus 100 determines whether an unselected area is present among the areas determined as having more FF cells than the connectable number for the last-stage clock buffer (step S2103). If no area is determined as having more FF cells than the connectable number, the determination of NO is made at step S2103.

If an unselected area is present (step S2103: YES), the circuit design support apparatus 100 selects one area from unselected areas among the areas determined as having more FF cells than the connectable number (step S2104). The circuit design support apparatus 100 detects an area adjacent to the selected area, from among areas determined as having fewer FF cells than the connectable number (step S2105). The circuit design support apparatus 100 determines whether an area adjacent to the selected area has been detected from among the areas having fewer FF cells than the connectable number (step S2106).

If an area adjacent to the selected area does not exist among the areas having fewer FF cells than the connectable number (step S2106: NO), the circuit design support apparatus 100 outputs information indicating the concentration of FF cells in the areas around the selected area (step S2109), and returns to step S2103.

If an area adjacent to the selected area exists among the areas having fewer FF cells than the connectable number (step S2106: YES), the circuit design support apparatus 100 defines “a difference=the number of FFs in the selected area−the connectable number” (step S2107). The circuit design support apparatus 100 determines whether multiple areas have been detected at step S2105 (step S2108).

If only one area has been detected (step S2108: NO), the circuit design support apparatus 100 defines “an available quantity=the connectable number−the number of the FF cells in the detected area” (step S2201) and determines whether the available quantity>the difference is satisfied (step S2202). If the available quantity>the difference is not satisfied (step S2202: NO), the circuit design support apparatus 100 proceeds to step S2109. If the available quantity>the difference is satisfied (step S2202: YES), the circuit design support apparatus 100 calculates the distance between the last-stage clock buffer cell in the detected area and each of the FF cells in the selected area (step S2203).

The circuit design support apparatus 100 selects in ascending order of distance and from among the FF cells in the selected area, FF cells equivalent in number to the difference (step S2204). The circuit design support apparatus 100 generates the correlation information 1100 in which the last-stage clock buffer cell in the detected area is correlated with the selected FF cells (step S2205), correlates and outputs the correlation information 1100 and the second layout data 12 (step S2206), and proceeds to step S2103.

If multiple areas have been detected (step S2108: YES), the circuit design support apparatus 100 defines “an overall available quantity=the number of the detected areas×the connectable number−the total number of the FF cells in the detected area” (step S2301) and determines whether the overall available quantity>the difference is satisfied (step S2302). If the overall available quantity>the difference is not satisfied (step S2302: NO), the circuit design support apparatus 100 returns to step S2109. If the overall available quantity>the difference is satisfied (step S2302: YES), among the detected areas, the circuit design support apparatus 100 detects among areas not defined as the destination area, the area having the smallest number of the FF cells, as a destination area (step S2303).

The circuit design support apparatus 100 defines “an available quantity=the connectable number−the number of the FF cells in the destination area.” (step S2304) and calculates the distance between the last-stage clock buffer cell in the destination area and each of the FF cells in the selected area (step S2305). The circuit design support apparatus 100 determines whether the available quantity>the difference is satisfied (step S2306). If the available quantity>the difference is satisfied (step S2306: YES), the circuit design support apparatus 100 selects from among the FF cells in the selected area and in ascending order of distance, FF cells equivalent in number to the difference (step S2307). If the available quantity>the difference is not satisfied (step S2306: NO), the circuit design support apparatus 100 selects from among the FF cells in the selected area and in ascending order of distance, FF cells equivalent in number to the available quantity (step S2308).

After step S2307 or step S2308, the circuit design support apparatus 100 generates the correlation information 1100 in which the last-stage clock buffer cell in the destination area is correlated with the selected FF cells (step S2309) The circuit design support apparatus 100 correlates and outputs the correlation information 1100 and the second layout data 12 (step S2310) The circuit design support apparatus 100 defines “a difference=the difference−the available quantity” (step S2311) and determines whether the difference>0 is satisfied (step S2312). If the difference is less than zero, this means that connection destinations are determined for all the FF cells in the selected area. If the difference>0 is not satisfied (step S2312: NO), the circuit design support apparatus 100 returns to step S2303. If the difference>0 is satisfied (step S2312: YES), the circuit design support apparatus 100 returns to step S2103.

If an unselected area is not present (step S2103: NO), the circuit design support apparatus 100 generates based on the second layout data 12 and the correlation information 1100, the third layout data 13, which indicates the connection between the FF cells and the last-stage clock buffer cells (step S2110), and terminates a sequence of the process.

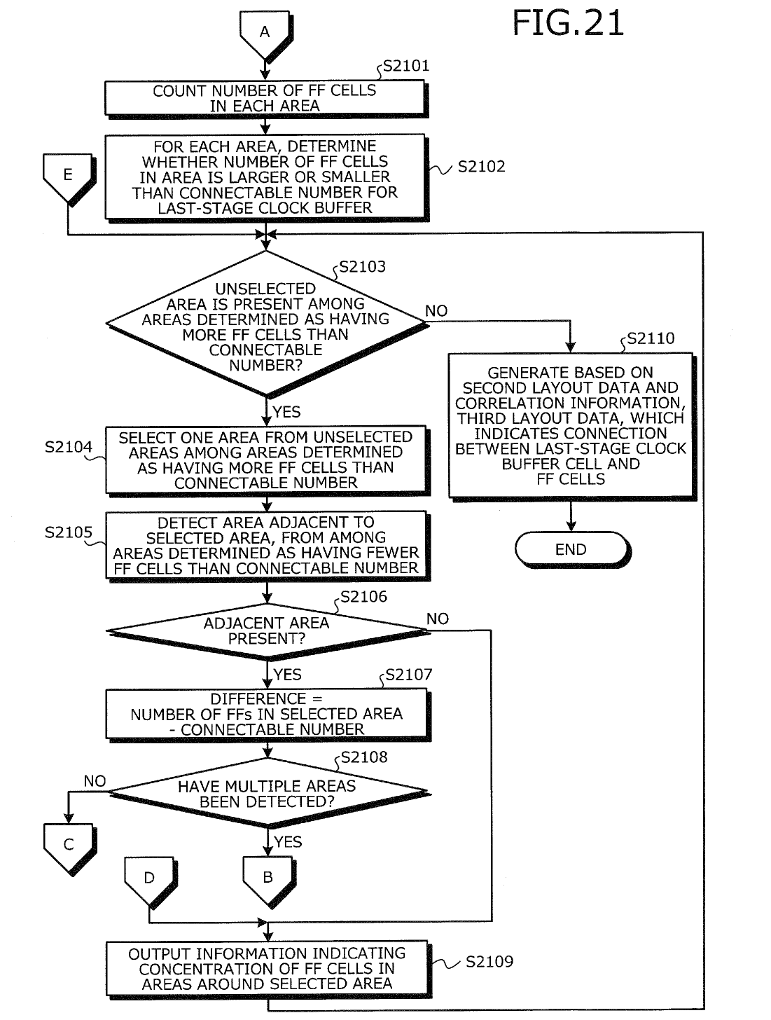

In the design support procedure depicted in FIG. 21, although an FF cell in an area determined as having a large number of FF cells is correlated with a clock buffer cell in a neighboring area determined as having a small number of FF cells, this is not a limitation. For example, the design supporting procedure may be performed such that a clock buffer cell in an area determined as having a small number of FF cells is correlated with an FF cell in a neighboring area determined as having the large number of FF cells.

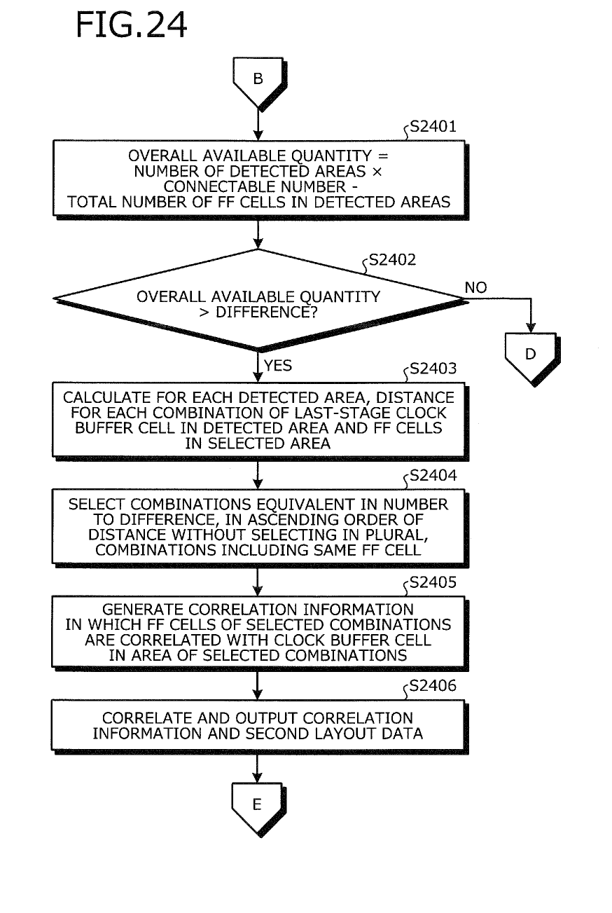

FIG. 24 is a flowchart of a design supporting process procedure example 2 by the circuit design support apparatus. A difference between the design supporting process procedure example 2 and the design supporting process procedure example 1 is the operation subsequent to step S2108 in the case of YES. Therefore, in FIGS. 20 to 22, the processes of the design supporting process procedure example 2 and the design supporting process procedure example 1 are the same and thus, FIGS. 20 to 22 will not be described in detail.

After step S2108, in the case of YES, the circuit design support apparatus 100 defines “an overall available quantity=the number of the detected areas×the connectable number−the total number of the FF cells in the detected areas” (step S2401) and determines whether the overall available quantity>the difference is satisfied (step S2402). If the overall available quantity>the difference is satisfied (step S2402: YES), the circuit design support apparatus 100 calculates with respect to each of the detected areas, a distance for each combination of the last-stage clock buffer cell in the detected area and the FF cells in the selected area (step S2403).

The circuit design support apparatus 100 selects combinations equivalent in number to the difference, in ascending order of distance without selecting in plural, combinations that include the same FF cell (step S2404). The circuit design support apparatus 100 generates the correlation information 1100 in which the FF cells of the selected combinations are correlated with the clock buffer cell in the area of the selected combinations (step S2405). The circuit design support apparatus 100 correlates and outputs the correlation information 1100 and the second layout data 12 (step S2406) and proceeds to step S2103. If the overall available quantity>the difference is not satisfied (step S2402: NO), the circuit design support apparatus 100 returns to step S2109.

As described above, the circuit design support apparatus 100 divides the cell arrangeable area by a constant interval, disposes in each area, at least one clock buffer cell capable of supplying clock signals, and then arranges FF cells. As a result, the clock skew can satisfy the constant condition regardless of the arrangement of the FF cells and the processing amount required for the arrangement of the FF cells can be reduced.

The circuit design support apparatus 100 generates the correlation information 1100 in which the FF cells are correlated with the clock buffer cell in the same area. As a result, the FF cells can be connected more easily to the closest clock buffer cells.

The circuit design support apparatus 100 determines whether the number of the FF cells in each area is larger or smaller than the number of clock signals that can be supplied, and generates the correlation information 1100 in which an FF cell in an area determined as having a larger number is correlated with a clock buffer cell in an area determined as having a smaller number. As a result, the FF cells up to the number of clock signals that can be supplied, can be connected to each of the clock buffer cells.

The circuit design support apparatus 100 generates the correlation information 1100 in which a clock buffer cell in an area that is among the areas determined as having a small number of FF cells and located adjacently to an area determined as having a large number of FF cells is correlated with FF cells in the area determined as having a large number of FF cells, where the number of FF cells correlated is equivalent to the difference of the FF cells in the area determined as having a large number of FF cells and the connectable number. As a result, the FF cells are connected to a nearby clock buffer cell, where FF cells equivalent in number to the connectable number are connected to each of the clock buffer cells.

The circuit design support apparatus 100 generates the correlation information 1100 in which a clock buffer cell in the area having the smallest number of FF cells among the adjacent areas is correlated with FF cells in the area determined as having a large number of FF cells, where the number of FF cells correlated is equivalent in number to the difference of the number of the FF cells in the area determined as having a large number of FF cells and the connectable number. As a result, even when FF cells cannot be connected to the closest clock buffer cell, more FF cells can be connected to a clock buffer cell at a shorter distance.

The circuit design support apparatus 100 calculates the distance between FF cells in an area determined as having a large number and an adjacent area, and generates the correlation information 1100 in which FF cells in the area and equivalent in number to the difference are correlated with a clock buffer cell in the adjacent area, in ascending order of distance. As a result, even when FF cells cannot be connected to the closest clock buffer cell, the FF cells and a clock buffer cell closer to one another can be connected.

If no adjacent area is obtained, the circuit design support apparatus 100 outputs information that indicates an arrangement of a large number of FF cells around the area is determined. As a result, a user can easily learn of a location where the clock skew cannot satisfy the constant condition because of a dense arrangement of FF cells.

The constant interval is a value that is based on the number of clock signals that can be supplied by a clock buffer cell. As a result, when the clock buffer cell and the FF cells in the same area are connected, the clock skew can satisfy the constant condition.

The circuit design support method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to an aspect of the embodiments, a reduction in the processing amount can be achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A circuit design support apparatus comprising
a processor that is configured to:
generate area information that indicates a plurality of areas obtained by dividing a predetermined area in a circuit by a constant interval;
generate first layout data that indicates arrangement of buffer cells capable of supplying clock signals to other cells, at least one buffer cell being disposed in each of the areas indicated by the area information;
generate based on the first layout data, second layout data that indicates arrangement of the buffer cells and arrangement of flip-flop cells disposed in the predetermined area; and
output the second layout data.

2. The circuit design support apparatus according to claim 1, wherein
the processor is further configured to generate for each of the areas and based on the second layout data, correlation information in which flip-flop cells in the area are correlated with a buffer cell in the area, and
the processor outputs the second layout data and the correlation information in a correlated manner.

3. The circuit design support apparatus according to claim 1, wherein
the processor is further configured to:
determine for each of the areas and based on the second layout data, whether the flip-flop cells in the area is of a number that is larger or smaller than the number of the clock signals that can be supplied by the buffer cell in the area, and
generate correlation information in which among the flip-flop cells in an area determined as having flip-flop cells of a number larger than the number of clock signals, a flip-flop cell excluding the flip-flop cells within the number of clock signals is correlated with a buffer cell in an area determined as having flip-flop cells of a number smaller than the number of clock signals, and
the processor outputs the second layout data and the correlation information in a correlated manner.

4. The circuit design support apparatus according to claim 3, wherein
the processor is further configured to detect from among areas determined as having flip-flop cells of a number smaller than the number of clock signals, an area that is adjacent to the area determined as having flip-flop cells of a number larger than the number of clock signals, and
the processor generates correlation information in which a flip-flop cell excluding the flip-flop cells within the number of clock signals is correlated with a buffer cell in the detected area.

5. The circuit design support apparatus according to claim 4, wherein
the processor detects an area in which the flip-flop cells are of a number that is smallest among the adjacent areas.

6. The circuit design support apparatus according to claim 4, wherein
the processor is further configured to:
calculate a distance between the buffer cell in the detected area and each of the flip-flop cells in the area determined as having flip-flop cells of a number larger than the number of clock signals, and
select in ascending order of the calculated distances and from among the flip-flop cells in the area determined as having flip-flop cells of a number larger than the number of clock signals, a flip-flop cell excluding the flip-flop cells within the number of clock signals, and
the processor generates correlation information in which the selected flip-flop cells are correlated with the buffer cell in the detected area.

7. The circuit design support apparatus according to claim 4, wherein
the processor is further configured to:
calculate for each of the detected areas, a distance between a buffer cell in the detected area and each of the flip-flop cells in the area determined as having flip-flop cells of a number larger than the number of clock signals, and
select from among combinations of the buffer cells in the detected areas and the flip-flop cells in the area determined as having the flip-flop cells of a number larger than the number of clock signals, combinations equivalent in number to a difference of the number of flip-flop cells in the area determined as having flip-flop cells of a number larger than the number of clock signals and the number of clock signals, the combinations being selected in ascending order of the calculated distances without selecting in plural, combinations that include the same flip-flop cell, and
the processor generates correlation information in which the flip-flop cells included in a selected combination are correlated with the buffer cell included in the selected combination.

8. The circuit design support apparatus according to claim 4, wherein
the processor, when an adjacent area cannot be acquired by detection, outputs information that indicates a presence of a large number of the flip-flop cells around the area determined as having flip-flop cells of a number larger than the number of clock signals, without generating the correlation information.

9. The circuit design support apparatus according to claim 1, wherein the constant interval is a value that is based on the number of clock signals that can be supplied by a buffer cell.

10. A circuit design support method comprising:
generating area information that indicates a plurality of areas obtained by dividing a predetermined area in a circuit by a constant interval;
generating first layout data that indicates arrangement of buffer cells capable of supplying clock signals to other cells, at least one buffer cell being disposed in each of the areas indicated by the area information; and
generating based on the first layout data, second layout data that indicates arrangement of the buffer cells and arrangement of flip-flop cells disposed in the predetermined area, wherein
the circuit design support methodic executed by a processor.

11. A non-transitory, computer-readable recording medium storing a circuit design support program that causes a computer to execute a process comprising:
generating area information that indicates a plurality of areas obtained by dividing a predetermined area in a circuit by a constant interval;
generating first layout data that indicates arrangement of buffer cells capable of supplying clock signals to other cells, at least one buffer cell being disposed in each of the areas indicated by the area information; and
generating based on the first layout data, second layout data that indicates arrangement of the buffer cells and arrangement of flip-flop cells disposed in the predetermined area, wherein
the circuit design support method is executed by a processor.
